(19) United States
(12) Patent Application Publication
(10) Pub. No.: US 2024/0118543 A1
(43) Pub. Date: Apr. 11, 2024

(54) PICTURE GENERATION APPARATUS OF HEAD-UP DISPLAY AND CONTROL METHOD THEREOF

(71) Applicant: HYUNDAI MOBIS CO., LTD., Seoul (KR)

(72) Inventors: Ki Hyuk SONG, Yongin-si (KR); Yu Jin SHIN, Seongnam-si (KR); Jeong Ho CHO, Yongin-si (KR); Hyun Woo KANG, Seongnam-si (KR); Yoo Na KIM, Suwon-si (KR); Jae Ho OH, Yongin-si (KR)

(73) Assignee: HYUNDAI MOBIS CO., LTD., Seoul (KR)

(21) Appl. No.: 18/351,028

(22) Filed: Jul. 12, 2023

(30) Foreign Application Priority Data
Oct. 7, 2022 (KR) 10-2022-0128400

(51) Int. Cl. G02B 27/01; G03H 1/22

(52) U.S. Cl. CPC G02B 27/0103; G03H 1/2205; G03H 1/2294; G02B 2027/0109; G03H 2001/2207

(57) ABSTRACT

A picture generation apparatus and a control method thereof are disclosed. An embodiment of the present disclosure provides a picture generation apparatus including a light source; a Spatial Light Modulator (SLM) configured to output an image using light transmitted from the light source; and a control unit configured to control the light source and the SLM based on at least one of illuminance of the surroundings or content of the image.

### CROSS-REFERENCE TO RELATED APPLICATIONS

The present application claims priority to Patent Application No. 10-2022-0128400, filed on Oct. 7, 2022 in Korea, the entire contents of which are incorporated herein by reference.

### TECHNICAL FIELD

The present disclosure relates to a picture generation apparatus of a head-up display and a control method thereof.

### BACKGROUND

The content described in the present section merely provides background information on the present disclosure and does not constitute the prior art.

A head-up display (HUD) is a device that allows a driver to see various pieces of information related to current speed, navigation, amount of fuel or the operation of a vehicle by illuminating a windshield of the vehicle. Since the driver may easily see various pieces of information related to the operation of the vehicle using the head-up display, the driver may keep his or her eyes forward with little dispersion of viewpoints while driving.

The head-up display may include a case in which a receiving space is formed therein, a Picture Generation Unit (PGU) that outputs an image related to the operation information of the vehicle, a reflection member, a dust cover, and the like. The head-up display is installed under the windshield of the vehicle due to its characteristics.

The PGU may include a light source that emits light, a Printed Circuit Board (PCB) on which the light source is disposed, and a Spatial Light Modulator that outputs an image.

On the other hand, the visibility of the image output by the PGU varies depending on the illuminance of the surroundings or the like. For example, in the daytime, sunlight may cause a user to perceive the image as faint or may cause the user to be unable to recognize the image. At night, due to a bright image a user may experience glare or a background may be reflected and visible, so that the visibility may be deteriorated. Therefore, it is necessary to improve the visibility of the image by adjusting the output condition of the image according to illuminance of the surroundings.

Further, even if the method of adjusting the output of the light source according to the illuminance of the surroundings is considered to improve the visibility of the image, an optical component may be damaged by heat due to the increased output of the light source, cost may be increased as a material with high heat-resistance is used to prevent the damage to the optical component, and there is technical limitation on minimum driving resolution of a light source driver.

### SUMMARY

In view of the above, the present disclosure provides a picture generation apparatus, which adjusts a gamma value based on illuminance of the surroundings and/or the content of an image, thus improving the visibility of the image, preventing damage to a component, and improving economic efficiency.

According to an embodiment, a picture generation apparatus adjusts a gamma value for each of a plurality of image areas, thus improving the visibility of an image.

The objectives to be achieved by the present disclosure are not limited to the above-mentioned objectives, and other objectives which are not mentioned will be clearly understood by those having ordinary skill in the art from the following description.

An embodiment of the present disclosure provides a picture generation apparatus including a light source; a Spatial Light Modulator (SLM) configured to output an image using light transmitted from the light source; and a control unit configured to control the light source and the SLM based on at least one of an illuminance of the surroundings and content of the image.

Another embodiment of the present disclosure provides a control method of a picture generation apparatus comprising a light source and a SLM, the method including a control step of controlling the light source and the SLM based on at least one of an illuminance of surroundings and content of an image to output the image.

Another embodiment of the present disclosure provides a head-up display including a picture generation apparatus configured to output an image; and one or more reflection members configured to reflect the image output from the picture generation apparatus, wherein the picture generation apparatus determines a gamma value based on at least one of an illuminance of surroundings and content of the image to output the image.

According to an embodiment, a picture generation apparatus is advantageous in that by adjusting a gamma value based on illuminance of the surroundings and/or the content of an image, the visibility of the image is improved, while preventing damage to a component and improving economic efficiency.

According to an embodiment, a picture generation apparatus is advantageous in that by adjusting a gamma value for each of a plurality of image areas, the visibility of an image is improved.

### BRIEF DESCRIPTION OF THE DRAWINGS

FIG. 1 is a block diagram illustrating the configuration of a picture generation apparatus according to an embodiment of the present disclosure.

FIG. 2 is a diagram illustrating a gamma curve.

FIG. 3 is a diagram for explaining how the picture generation apparatus according to an embodiment of the present disclosure determines a gamma value based on illuminance of the surroundings.

FIG. 4 is a graph illustrating first to third gamma values applicable to the picture generation apparatus according to an embodiment of the present disclosure.

FIG. 5 is a diagram for explaining how the picture generation apparatus according to an embodiment of the present disclosure adjusts the output of a light source based on the content of an image.

FIG. 6 is a flowchart illustrating a control method of a picture generation apparatus according to an embodiment of the present disclosure.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components.

When a component is described as being ‘linked,’ ‘coupled,’ or ‘connected’ to another component, it should be understood that the component may be directly linked or connected to the other component, and that yet another component may be ‘linked,’ ‘coupled,’ or ‘connected’ between each component.

Throughout the present specification, when a part ‘includes’ or ‘comprises’ a component, the part is meant to further include other components, not to exclude thereof unless specifically stated to the contrary.

The terms such as ‘unit’, ‘module’, and the like refer to one or more units for processing at least one function or operation, which may be implemented by hardware, software, or a combination thereof.

Unless stated to the contrary, a description of any one embodiment may also be applied to other embodiments.

The following detailed description, together with the accompanying drawings, is intended to describe exemplary embodiments of the present invention and is not intended to represent the only embodiments in which the present invention may be practiced.

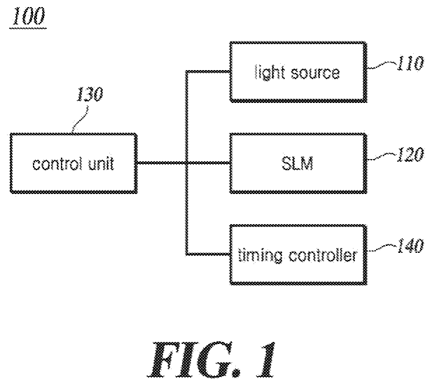

FIG. 1 is a block diagram illustrating the configuration of a picture generation apparatus according to an embodiment of the present disclosure.

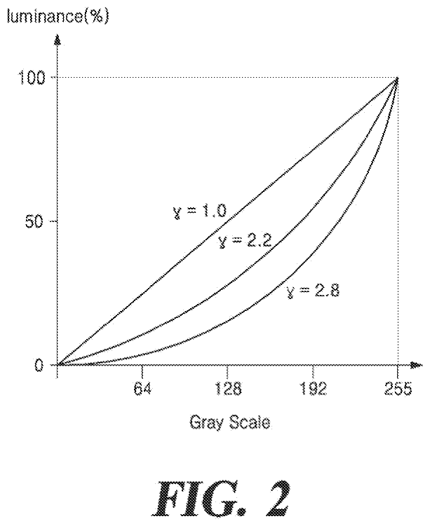

FIG. 2 is a diagram illustrating a gamma curve.

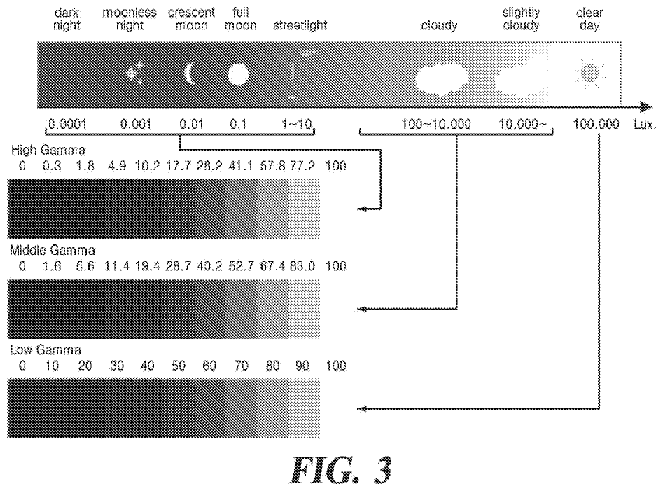

FIG. 3 is a diagram for explaining how the picture generation apparatus according to an embodiment of the present disclosure determines a gamma value based on an illuminance of the surroundings.

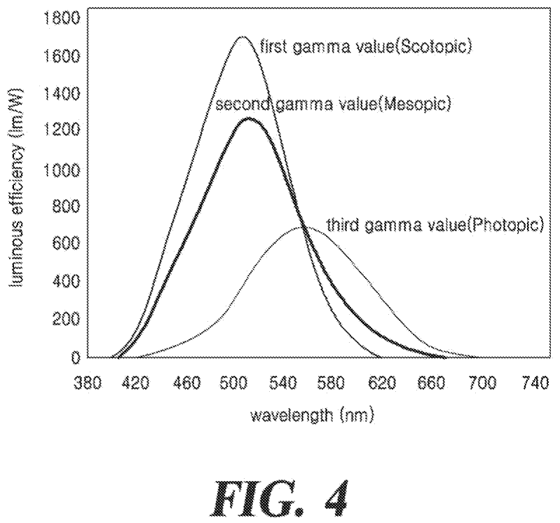

FIG. 4 is a graph illustrating first to third gamma values applicable to the picture generation apparatus according to an embodiment of the present disclosure.

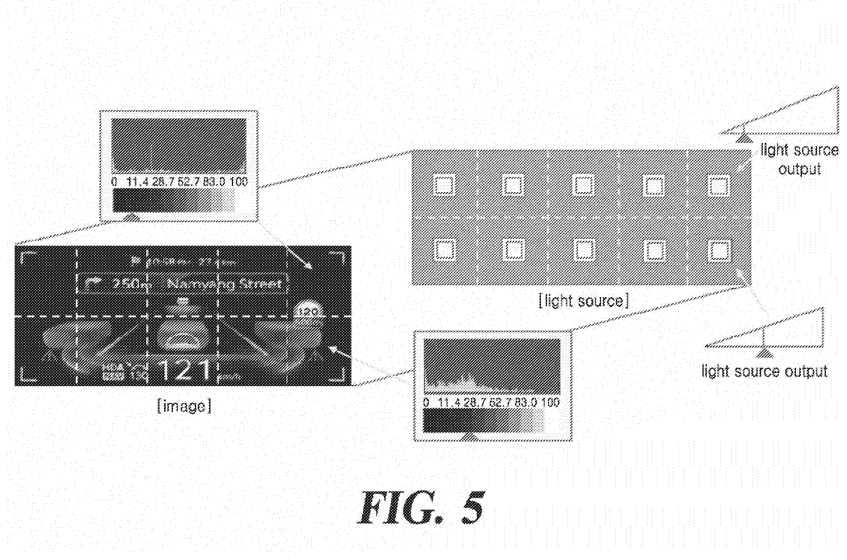

FIG. 5 is a diagram for explaining how the picture generation apparatus according to an embodiment of the present disclosure adjusts the output of a light source based on the content of an image.

Referring to FIGS. 1 to 5, the picture generation apparatus 100 according to an embodiment of the present disclosure may include a light source 110, a Spatial Light Modulator (SLM) 120, a control unit 130, and a timing controller 140.

The light source 110 emits light so that the SLM 120 outputs an image. The light source 110 may be disposed on a Printed Circuit Board (PCB; not shown), but is not necessarily limited thereto. The number of light sources 110 may be plural. For example, as will be described later, when the image output by the SLM 120 is divided into a plurality of areas, a plurality of light sources 110 may be provided to correspond to a plurality of areas of the image, respectively. The control unit 130 may control the intensity (output) of light emitted by the light source 110 based on the content of the image. The light source 110 may be a Light Emitting Diode (LED).

The SLM 120 outputs the image using light transmitted from the light source 110. The SLM 120 is disposed in front of the light source 10 with respect to the travel path of the light emitted from the light source 110. When the picture generation apparatus 100 according to the present disclosure is used for a head-up display of a vehicle, the image outputted from the SLM 120 may be reflected by one or more reflection members and then displayed on a windshield of the vehicle or the like. The SLM 120 may be controlled by the control unit 130. The SLM 120 may include a Liquid Crystal Display (LCD) or the like.

The SLM 120 may output the image so that the gradation of the image changes based on a gamma value determined by the control unit 130. Here, the gamma value means a value for determining a correlation between the gray scale of an input signal and the luminance of an image, as shown in FIG. 2. When the gamma value is high (e.g., the gamma value of 2.8 in FIG. 2), the luminance increases gently and then increases sharply according to the gray scale of the input signal. When the gamma value is low (e.g., the gamma value of 1.0 in FIG. 2), a change according to the gray scale of the input signal becomes relatively close to linear. The gradation means a concentration transition step from the darkest part to the lightest part of the image. That is, the gradation means a change rate of luminance (or concentration) of the image. Referring to the strip image of FIG. 3 showing the gradation according to the gamma value, as the gamma value is relatively higher (High Gamma), the change (gradation) of luminance (or concentration) is gentle and then becomes sharp. In contrast, as the gamma value becomes low (Low Gamma), the change in luminance (or concentration) becomes close to linear. That is, a change in the gamma value means that the gradation (the change rate of the luminance or concentration) is changed. The picture generation apparatus 100 according to the present disclosure adjusts the gamma value based on the illuminance of the surroundings and/or the content of the image, the gradation of the image is changed accordingly, and the image is output based on the changed gradation, so that the visibility of the image is significantly improved according to the surrounding environment.

The SLM 120 may output the image by dividing it into a plurality of areas. The SLM 120 may output images not only by varying the gradation of each of the plurality of image areas but also by varying the change rate (gamma value) of the gradation of each area. The picture generation apparatus 100 according to the present disclosure divides the image into a plurality of areas and determines the gamma value for each area, thus further improving the visibility of the image.

The control unit 130 controls the light source 110 and the SLM 120 based on the illuminance of the surroundings (e.g., the outside of the vehicle when installed in the vehicle) of the picture generation apparatus 100 and/or the content of the image. The control unit 130 determines the gamma value based on the illuminance of the surroundings and/or the content of the image. Here, the illuminance of the surroundings means the outside of the vehicle equipped with the picture generation apparatus 100, and may be detected through a separately provided illumination sensor or the like, and the detected information is transmitted to the control unit 130. Further, the expression “the gamma value may be determined based on the illuminance of the surroundings” includes the meaning that the gamma value may be determined differently according to environments having different illumination levels, such as day, night, or dawn. For example, the control unit 130 may determine the gamma value as a relatively large value so that the change in concentration (or luminance) is gentle and then rapid (e.g., the gamma value of 2.8 in FIG. 2) when the illuminance of the surroundings is low (e.g., night, see FIG. 3). In contrast, the control unit 130 may determine the gamma value as a relatively small value so that the change in concentration (or luminance) approaches a linear change (e.g., the gamma value of 1.0 in FIG. 2), when the illuminance of the surroundings is high (e.g., day, see FIG. 3). The control unit 130 may change the determined gamma value based on the illuminance of the surroundings and/or the content of the image.

The control unit 130 controls the light source 110 and the SLM 120 so that the gradation of the image is adjusted based on the determined gamma value. That is, the control unit 130 controls the light source 110 and the SLM 120 so that the luminance (or concentration) of the image is adjusted based on the determined gamma value. The picture generation apparatus 100 according to the present disclosure determines the gamma value based on the illuminance of the surroundings and/or the content of the image, and controls the light source 110 and the SLM 120 so that the gradation of the image is adjusted based on the determined gamma value, thus improving the visibility of the image, preventing damage to a component, and improving economic efficiency.

Referring to FIG. 4, the gamma value may include a first gamma value (Scotopic), a second gamma value (Mesopic), and a third gamma value (Photopic). For example, the control unit 130 may determine the gamma value as the first gamma value (Scotopic) in a dark environment such as at night. The control unit 130 may determine the gamma value as the third gamma value (Photopic) in a bright environment such as in the daytime. The control unit 130 may determine the gamma value as the second gamma value (Mesopic) in an environment where brightness is intermediate between daytime and nighttime, such as at dawn. However, it should be noted that the gamma value applicable to the picture generation apparatus 100 of the present disclosure is not limited to the first to third gamma values, and various gamma values may be applied according to the illuminance of the surroundings and/or the content of the image.

Referring to FIG. 5, the image output by the picture generation apparatus 100 according to the present disclosure may be divided into a plurality of areas, and the control unit 130 may determine the gamma value for each of the plurality of areas. For example, a relatively high value may be determined as the gamma value for an image area containing a lot of dark colors such as black, while a relatively low value may be determined as the gamma value for an image area including a lot of bright colors such as white.

When the image is divided into a plurality of areas, the plurality of light sources 110 may be configured to correspond to the respective image areas as described above. In this case, the control unit 130 may determine the output of each light source 110 based on the distribution of gradation of each image area. For example, when most of the pixels in a specific image area display colors with low luminance (high concentration), the control unit 130 may set the corresponding output of the light source 110 to be relatively low (see FIG. 5). In contrast, when most of the pixels in the image area display colors with high luminance (low concentration), the control unit 130 may set the corresponding output of the light source 110 to be relatively high. As described above, the picture generation apparatus 100 according to the present disclosure divides the image into a plurality of areas and adjusts the output of the light source 110 based on the content of the image, thereby further improving the visibility of the image.

The control unit 130 may correct the gradation of the image by comparing gamma values of the plurality of areas of the image with each other. At this time, the control unit 130 may correct the gradation of the image using the gamma curve (see FIG. 2). For example, when the image is divided into ten areas \textcircled{1} to \textcircled{10}, the control unit 130 may correct the gradation of the image by comparing the gamma value of the area \textcircled{1} derivable from the gamma curve with the gamma values of each of the areas \textcircled{2} to \textcircled{10}. At this time, the control unit 130 may correct the gradation of the image using a linear interpolation method. By repeating this method for each of the areas \textcircled{1} to \textcircled{10}, the gradation of the image may be corrected. Thus, it is possible to prevent image nonuniformity resulting from displaying the image by dividing it into a plurality of areas.

The control unit 130 may control the light source 110 and the SLM 120 based on a user's setting. For example, when a user sets to output the image in a high luminance mode in the daytime and to output the image in a high contrast mode at night, the control unit 130 may control the light source 110 and the SLM 120 to output the image based on a gamma value (may be measured in advance and set through an experiment or the like) suitable for the corresponding mode. Further, the user may set whether to apply a static or dynamic gamma value depending on the illuminance of the surroundings and/or the content of the image. Of course, the gamma value may be set to be dynamically adjusted only during the day or to be adjusted only at night.

The control unit 130 and the SLM 120 may be synchronized in time by a separately provided timing controller 140. Thus, the SLM 120 may output the image based on the gamma value adjusted by the control unit 130 according to a change in time.

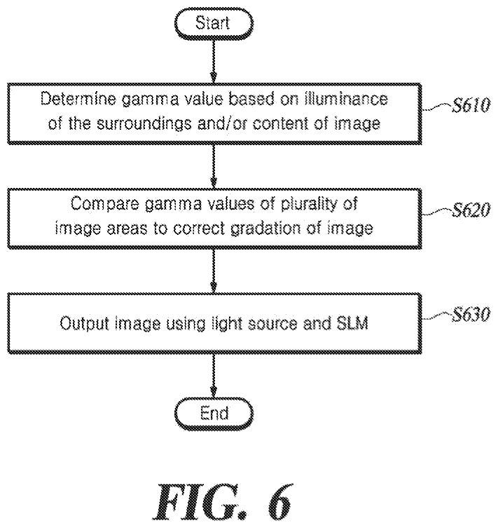

FIG. 6 is a flowchart illustrating a control method of a picture generation apparatus according to an embodiment of the present disclosure.

Before the control method of the picture generation apparatus 100 according to the present disclosure is described in detail with reference to FIG. 6, it should be noted that the overlapping description of the above-described picture generation apparatus 100 and the control method of the picture generation apparatus 100 will be omitted, but the contents related to the picture generation apparatus 100 may be equally applied to the control method of the picture generation apparatus 100 as long as they are consistent with each other.

The control unit 130 determines the gamma value based on the illuminance of the surroundings and/or the content of the image (S610). The control unit 130 may determine the gamma value based on the illuminance of the surroundings and/or the content of the image. When the image is divided into a plurality of areas, the control unit 130 may determine the gamma value for each of the plurality of image areas. The SLM 120 may output the image based on the gamma value determined by the control unit 130.

The control unit 130 compares the gamma values of the plurality of image areas and corrects the gradation of the image (S620). When the image is divided into the plurality of areas, the control unit 130 may compare each of the gamma values of the plurality of image areas with each other to correct the gradation of the image. Thus, it is possible to prevent image nonuniformity resulting from the image being divided into a plurality of areas and displayed.

The control unit 130 outputs the image using the light source 110 and the SLM 120 (S630). The control unit 130 determines the gamma value based on the illuminance of the surroundings and/or the content of the image, and controls the light source 110 and the SLM 120 so that the gradation of the image is adjusted based on the determined gamma value.

The flowchart of the present disclosure describes processes as being sequentially executed, but this is merely illustrative of the technical idea of an embodiment of the present disclosure. In other words, since it is apparent to those having ordinary skill in the art that an order described in the flowchart may be changed or one or more processes may be executed in parallel without departing from the essential characteristics of an embodiment of the present disclosure, the flowchart is not limited to a time-series order.

Various implementations of systems and techniques described herein may be realized as digital electronic circuits, integrated circuits, field programmable gate arrays (FPGAs), application specific integrated circuits (ASICs), computer hardware, firmware, software, and/or combinations thereof. These various implementations may include one or more computer programs executable on a programmable system. The programmable system includes at least one programmable processor (which may be a special-purpose processor or a general-purpose processor) coupled to receive and transmit data and instructions from and to a storage system, at least one input device, and at least one output device. The computer programs (also known as programs, software, software applications or codes) contain commands for a programmable processor and are stored in a “computer-readable recording medium”.

The computer-readable recording medium includes all types of recording devices in which data readable by a computer system is stored. Such a computer-readable recording medium may be a non-volatile or non-transitory medium, such as ROM, CD-ROM, magnetic tape, floppy disk, memory card, hard disk, magneto-optical disk, or a storage device, and may further include a transitory medium such as a data transmission medium. In addition, the computer-readable recording medium may be distributed in a computer system connected via a network, so that computer-readable codes may be stored and executed in a distributed manner.

Various implementations of systems and techniques described herein may be embodied by a programmable computer. Here, the computer includes a programmable processor, a data storage system (including volatile memory, non-volatile memory, or other types of storage systems, or combinations thereof) and at least one communication interface. For example, the programmable computer may be one of a server, a network device, a set top box, an embedded device, a computer expansion module, a personal computer, a laptop, a personal data assistant (PDA), a cloud computing system, or a mobile device.

Although exemplary embodiments of the present disclosure have been described for illustrative purposes, those having ordinary skill in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skills would understand that the scope of the claimed invention is not to be limited by the above explicitly described embodiments but by the claims and equivalents thereof.

What is claimed is:

1. A picture generation apparatus comprising:
a light source configured to generate and transmit light;
a spatial light modulator (SLM) configured to output an image using light transmitted from the light source; and
a control unit configured to control the light source and the SLM based on at least one of an illuminance of surroundings and content of the image.

2. The picture generation apparatus of claim 1, wherein the control unit is configured to determine a gamma value based on at least one of the illuminance of the surroundings and the content of the image.

3. The picture generation apparatus of claim 2, wherein the control unit is configured to control the light source and the SLM to adjust a gradation of the image based on the determined gamma value.

4. The picture generation apparatus of claim 2, wherein the gamma value comprises first, second and third gamma values.

5. The picture generation apparatus of claim 2, wherein:
the image comprises a plurality of areas, and
the control unit is configured to determine the gamma value for each of the plurality of areas.

6. The picture generation apparatus of claim 5, wherein the light source comprises a plurality of light sources disposed corresponding to the plurality of areas of the image, respectively.

7. The picture generation apparatus of claim 6, wherein the control unit is configured to control the plurality of light sources based on a distribution of gradation of each of the plurality of areas.

8. The picture generation apparatus of claim 6, wherein the control unit is configured to compare each of the gamma values of the plurality of areas to correct the gradation of the image.

9. The picture generation apparatus of claim 8, wherein the control unit is configured to corrects the gradation of the image using a linear interpolation method.

10. The picture generation apparatus of claim 1, further comprising a timing controller.

11. A method of controlling a picture generation apparatus comprising a light source and a spatial light modulator (SLM), the method comprising controlling, based on at least one of an illuminance of surroundings or content of an image, the light source and the SLM to output the image.

12. The control method of claim 11, further comprising determining a gamma value based on at least one of the illuminance of the surroundings and the content of the image.

13. The control method of claim 12, wherein controlling the light source and the SLM comprises adjusting a gradation of the image based on the gamma value.

14. The control method of claim 12, wherein determining the gamma value comprises determining the gamma value for each of a plurality of areas of the image.

15. The control method of claim 14, further comprising comparing gamma values of the plurality of areas to correct the gradation of the image.

16. A head-up display comprising:
a picture generation apparatus configured to output an image; and
one or more reflection members configured to:
reflect the image output from the picture generation apparatus; and
determine a gamma value based on at least one of an illuminance of surroundings and content of the image to output the image.
